(19) United States
(12) Patent Application Publication
(10) Pub. No.: US 2009/0172600 A1
(43) Pub. Date: Jul. 2, 2009

(54) System and Method of Orienting Building Representations

(76) Inventors: Zhang YaJun, Shanghai (CN); Janet Jin, Shanghai (CN); Enyi Chen, Beijing (CN); Rui Zhang, Beijing (CN); Thomas A. Plocher, Hugo, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/965,289

(22) Filed: Dec. 27, 2007

(51) Int. Cl. G06F 3/048

(52) U.S. Cl. 715/851

(57) ABSTRACT

Systems and methods are disclosed to display compass-type indicia relative to a three dimensional computer generated image of a building or a region. Such images, presented on multi-dimensional computer driven display devices have associated therewith directional indicating indicia, such as a compass-like image, which seamlessly provide visual and spatial directional information to a viewer even as the images are being rotated or enlarged, such as by zooming into a specific space of the building or region.

### FIELD

The invention pertains to systems and methods of presenting visually on a multi-dimensional display a computer generated image of a building or region of interest. More particularly, the invention pertains to such images which carry directional specifying indicia to assist a viewer in quickly and accurately understanding the orientation of the building or region.

### BACKGROUND

Increasingly, 3D models of large buildings are used in graphical displays to support situation awareness in a variety of domains including firefighting, building security, and HVAC management. As those of skill in the art will understand, a variety of software is available to create renderings of the various floors of buildings. One system and process for presenting and rotating building images are disclosed and claimed in U.S. patent application Ser. No. 11/274,443 entitled “Systems and Methods for Rendering Building Spaces”, filed Nov. 15, 2005, assigned to the assignee hereof, and incorporated by reference herein.

However, the end-user may be unfamiliar with the building presented in the display. Sometimes, the user will suffer from the disorientation as he/she views and interacts with the 3D building graphics. On the other hand, the majority of end-users' tasks are time critical. For example, the security guard needs to locate to the place of interest for surveillance or checking, and the firefighter needs to find the route to the place in alarm or in emergency.

The end-users can't afford to expend limited cognitive resources on trying to comprehend building orientation. Rather, they need to understand the directional orientation of the building as soon as possible. Current designs for representing cardinal directions in display graphics rely on a compass placed at the corner of the display area. There are two problems with that. One, the compass is visually and cognitively detached from the building to which it relates. The design forces the user to move back and forth visually between the compass and building and to expend cognitive energy to spatially integrate the two. Both contribute to the user's workload and detract from his/her primary operational task. Second, a compass simply placed at the side of a display can be easily occluded by the building image or UI widgets rotating in a 3D environment.

Thus, methods are needed to improve compass design in 3D building graphics. The new methods need to seamlessly integrate compass and 3D building graphics both visually and spatially. Through those new methods, the user can acquire the directional orientation of the building in a glance and facilitate locating the position of interest.

### BRIEF DESCRIPTION OF THE DRAWINGS

FIG. 1 is a block diagram of a system that embodies the invention;

FIG. 2 is illustrates in a first display a method of providing directional information to a user in accordance with the invention;

FIG. 3 a plan view illustrates in a plan view, a variation of the display of FIG. 2;

FIG. 4 is an enlarged view of the image of FIG. 1;

FIG. 5 is a further enlarged view illustrating additional aspects of the method illustrated by the image of FIG. 1;

FIG. 6 is an image that illustrates an alternate method of providing orientation information to a user;

FIG. 7 is an enlarged view illustrating additional aspect of the method illustrated in FIG. 6;

FIG. 8 is an image illustrating selection of a portion of the view of FIG. 7;

FIG. 9 is an image which illustrates another method of providing orientation information to a user;

FIG. 10 is an image which illustrates yet another method of providing orientation information to a user;

FIG. 11 is an image of an enlarged portion of the image of FIG. 10 illustrating further features of the method thereof;

FIG. 12 is an image which illustrates another method of providing orientation information to a user;

FIG. 13 is yet another image which illustrates another method of providing orientation information to a user;

FIGS. 14A,B illustrate variations of the orientation method illustrated in FIG. 1 as well as methods of the other above noted figures; and

FIG. 15 is an image of yet another direction indicating set of symbols usable with the methods of the above noted figures.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Systems and methods in accordance with the invention provide seamless visual presentations of 3D building images and associated direction indicating symbols. In one aspect, each cardinal direction arrow (E, W, N, S) of the compass can be displayed at ground level outside the image of the building. This configuration eliminates the problem of the directional indicators, for example, compass occluding building features.

In this method, the directional cues including arrows and characters (such as “N”, “E”, “S”, “W” indicating north, east, south and west) are shown on the ground outside the building. When user manipulates the building, the directional cues follow. If the user zooms, the compass' behavior can be different from that of the building.

In order to make sure the compass is always readable, its directional labels (N-S-E-W) can be limited to always fall within a predetermined maximum size and minimum size That is, such indicators will not be zoomed down or up to an unreadable size, Their size will be limited so as to still be readable. Thus the zoom level of the indicators, such as arrows and labels may often be different from that of the image of the building.

When the image of the building is zoomed in to certain level, the indicators can be locked on the screen in a predetermined position at a maximum readable size. In this configuration they will not be displayed out of the display area.

In another method which embodies the invention, the directional indicators, the compass arrows, can be located on roads and paths outside the building and interior hallways. When an object (e.g., floor or room) is selected, the indicator, such as compass arrows can be placed adjacent or around the selected object. This configuration provides real-time cues for orienting the objects.

In the above noted method, the directional cues including arrows and characters (such as “N”, “E”, “S”, “W” indicating north, east, south and west) can be visualized on the adjacent roads, pointing along the road's direction. When zooming into the interior of the building, the directional cues will be visualized on corridors and paths which are in the display area. When an object (i.e. floor, room) is selected, the context-aware directional cues are shown outside the object. This function can be used alone or be integrated with other methods.

In yet another method the compass arrows can be displayed above the image of the building around a centric axis. When user manipulates the building, the directional cues follow.

Alternately, the indicator, a compass, can be visually presented around the cursor. This indicator configuration can be small and half transparent. The user can move the cursor to any place of interest and the compass follows, indicating directions in real-time. A “pick” and “place” function can be provided to place indicator, or, compass at any location of interest.

As noted previously, the directional cues including arrows and characters (such as “N”, “E”, “S”, “W” indicating north, east, south and west) are visualized around the cursor which has 3-dimensional (3D) data. When the cursor is moved in the 3D building model the directional cues will move with it. This function can be accessed via button or hotkey. Another alternative of this method is using a “place compass” function to pick up the compass and place it through clicking or dropping in any position of interest in or around the building to show the directional cues. This function can also be accessed via a light button or hotkey.

In yet another method the directional cues, the compass symbol, (such as “N”, “E”, “S”, “W” indicating north, east, south and west) can be located outside the building and above the floor number object, closely integrating the compass and the floor numbers.

Alternately, the directional cues, such as a compass, including arrow-shape indicators and characters (such as “N”, “E” indicating north and east) can be presented in a small inset window depicting both the building in 3D and the compass indicator. The composite image in the inset rotates as the image of the 3D building in the main window rotates and maintains the same viewer perspective.

In all of the above configurations, the directional indicatiors, the arrows and characters “N”, “E” can be both parallel or vertical to the image of the floor; or the arrows can be presented parallel to the floor while the characters “N” and “E” are vertical to the floor.

In yet another aspect of the invention, each directional defining character can be visualized on a cube i.e. six “N”s on the six surfaces of a cube (one “N” on one surface). Thus the user can see the character from any viewpoint. Both the character “N” and the arrow which indicates north can be distinctively displayed through color-coding and/or scaling and/or animation.

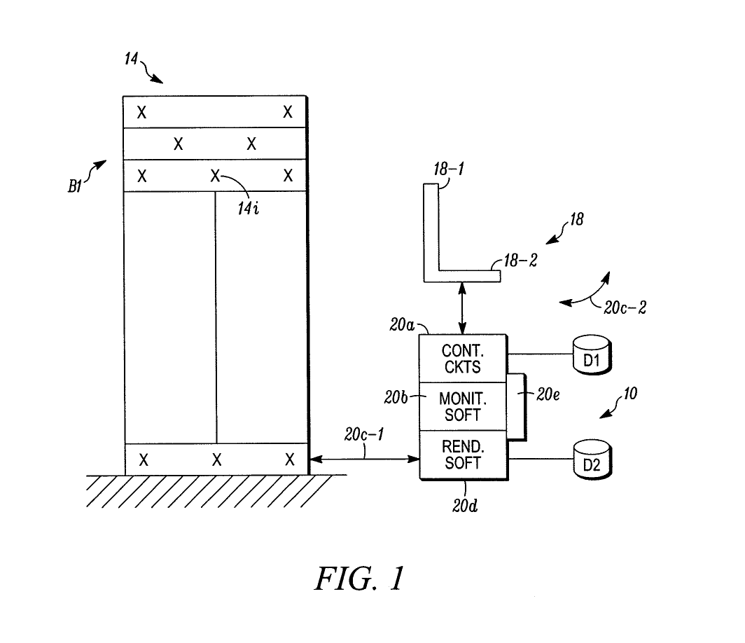

FIG. 1 illustrates a system 10 which might be distributed throughout a plurality of floors of a building B1 for purposes of monitoring various conditions throughout the building. Representative conditions could include fire, smoke, gas, operation of HVAC systems, illumination systems, and/or security systems all without limitation.

System 10 could incorporate a plurality of ambient condition detectors scattered throughout the building indicated generally at 14 for purposes of monitoring various conditions throughout the building of B1. Signals that pertain to outputs from detectors 14 could be coupled to a fire situation control and display unit 18. The unit 18 could be in wired or wireless communication with various of the detectors 14 scattered throughout the building B1.

Information pertaining to conditions within the building B1 could be presented on one or more local visual displays, such as display unit 18-1. Keyboard 18-2 is available for entry of commands to system 10 and/or control of building B1 images on unit 18-1. The display 1 keyboard unit 18-1, -2 could be implemented as a personal computer in wired or wireless communication with control circuits 20a. Such displays could provide information pertaining to the state of one or more of the members 14i of the plurality 14 of ambient condition detectors.

Unit 18 can be implemented with control circuits 20a which could include one or more programmable processors. It will be understood that the processors need not all be located physically near one another. They could communicate via one or more networks.

Unit 18 can also include control and monitoring software 20b executable by one or more of the processors of control circuits 20a. The software 20b implements communications with the plurality of ambient condition detectors 14, as well as other displaced devices via a wired and/or wireless medium indicated generally at 20c-1. Communications can be provided to other sites via a wired or wireless medium 20c-2.

The unit 18 can also include software 20d, discussed in more detail subsequently, for presenting or rotating one or more renderings of the building B1. The building images can be viewed from various orientations. The renderings in 2D or 3D form, can be presented locally on two-dimensional visual display unit 18-1, or on display unit 20e. The displays can be viewed by first responders in the vicinity for purposes of understanding the layout of the building B1, including location of stairways and elevators in the building, location and arrangement of the members of the plurality of detectors 14. Those detectors which are emitting indications of an alarm condition can be highlighted.

Images presented on the display units are rotatable so that relationships of developing conditions to building structures can be easily seen. It will be understood that two or three dimensional-type display units come within the sprit and scope of the invention.

Monitoring and rendering software 20b, d would be stored in computer readable form on magnetic or optical disk drives D1, D2. A building database can be stored in either or both of disk drives D1, D2. Rendering software 20d can also include software for generating and presenting direction indicating indicia as described subsequently.

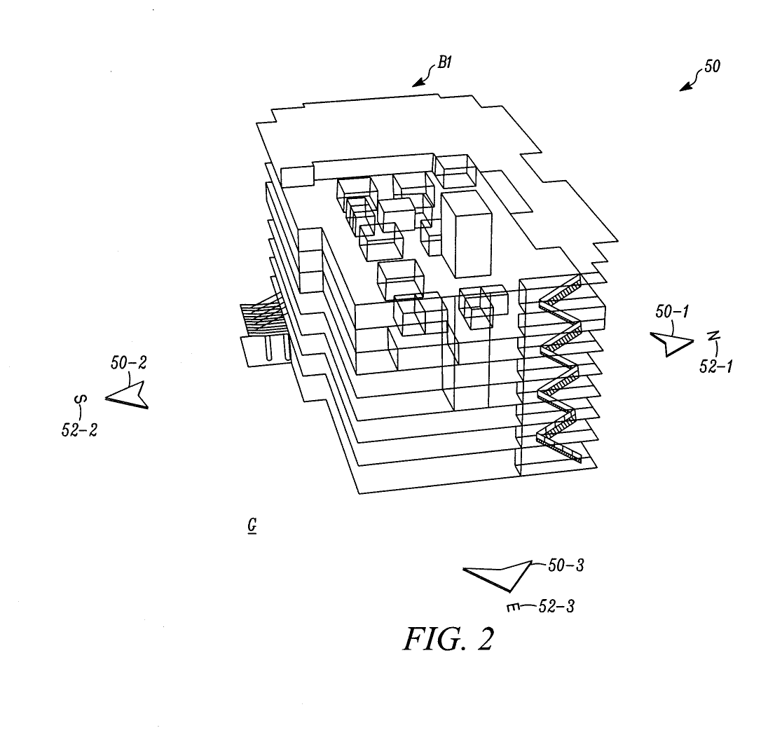

FIG. 2 illustrates a display of a type that might be presented on unit 18-1 or 20e of a building such as building B1. The information for the display of FIG. 2 could be drawn from information pre-stored on either one of the storage units D1, D2 and presented using building rendering software 20d. As illustrated in FIG. 2, compass-type directional indicating indicia including arrow shaped indicators 50-1, -2 and -3 along with associated direction indicating alphabetical characters 52-1, 52-2 and 52-3. As illustrated in display or image 50, the directional indicia are illustrated and presented at ground level outside of the image of the building B1. As the user manipulates the building, by rotation, enlargement or the like, the directional indicating cues 50, 52 will be automatically manipulated along with the building by software 20d.

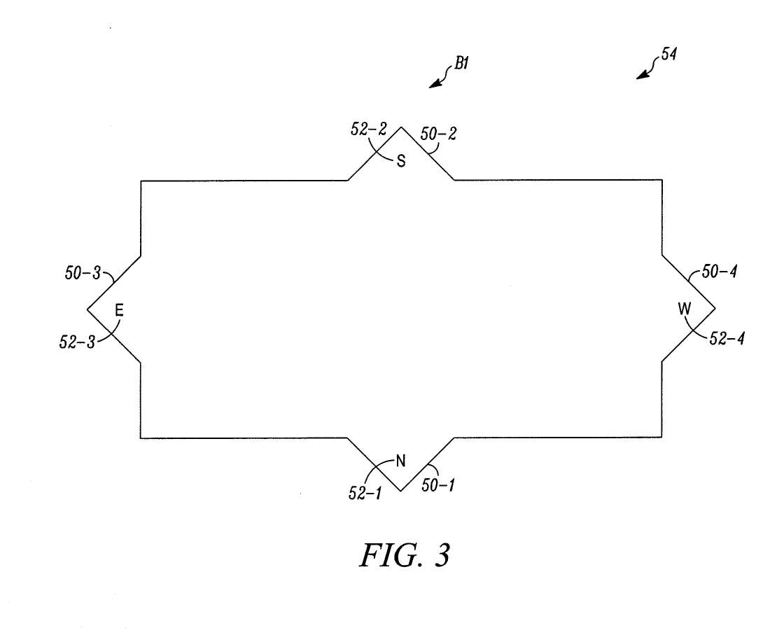

FIG. 3 is an alternate view 54 of a top plan view of the building B1 with the directional indicating indicia 50, 52 presented adjacent to an overall view of building B1 at ground level.

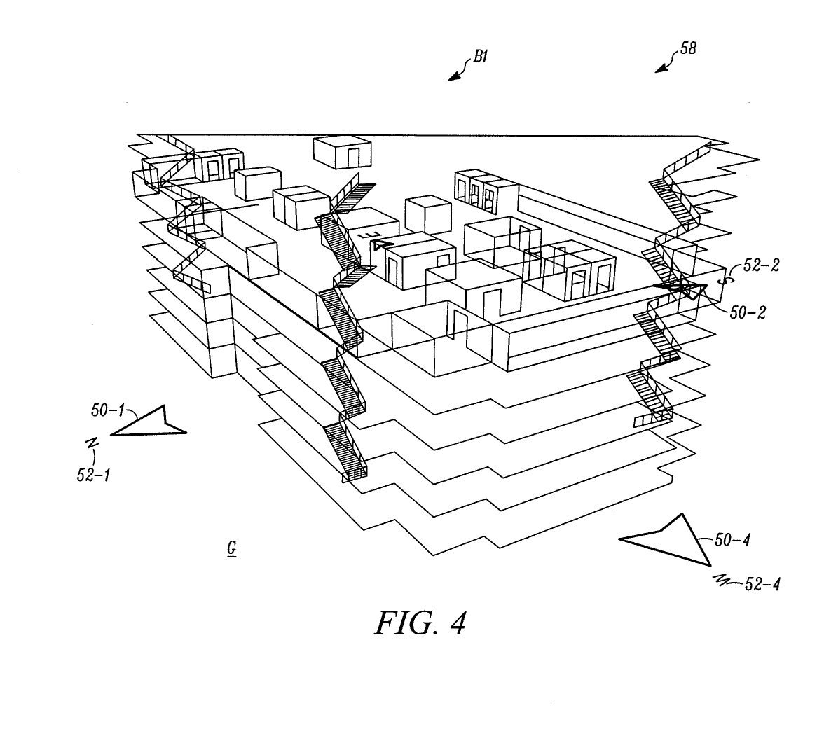

FIG. 4 illustrates an image 58 presentable by the rendering software 20d on the display 18-1 or 20e where the viewer or operator has carried out a zoom function relative to the building B1. In this instance, the behavior of the direction or compass-type elements 50, 52 varies from that of the image representing the portion of the building B1. So that the direction indicating indicia are always available, the size of the elements 50, 52 will be enlarged or decreased in accordance with the direction of the zooming of the image of the building B1 with limitations imposed as to maximum and minimum size so that they continue to be readily visible and readable by an individual viewing the unit 18-1 or 20e. In this regard, when the building B1 is zoomed out so it is to be very small for an overall view, the associated compass-type indicia 50, 52 will be maintained at a readable minimum size. When the operator zooms in on the building B1 to look at a particular enlarged region thereof, the indicators 50, 52 will be maintained, on the display 58, at a readable maximum size.

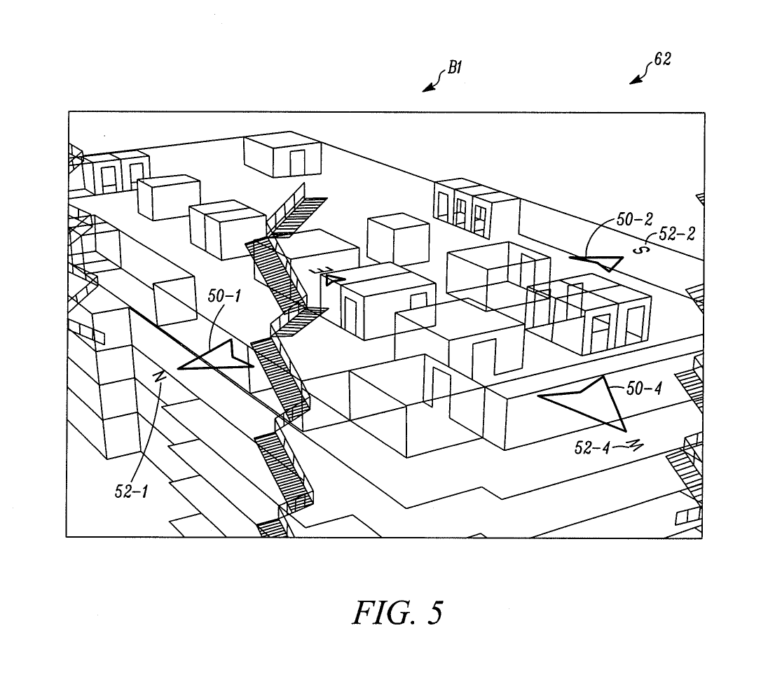

As illustrated in FIG. 5, with image 52, the operator has zoomed in even further on the image of the building B1 producing an enlargement of a particular portion thereof. However, the direction or indicating indicia 50, 52 not only are presented at a predetermined maximum size they are also relocated within the scope of the zoomed image 62 so that they can continue to be visible to viewer of the unit 18-1 or 20e. Hence, if the viewer rotates the image of FIG. 5, the directional indicating indicia 50, 52 will continue to be present on the display at a readable size.

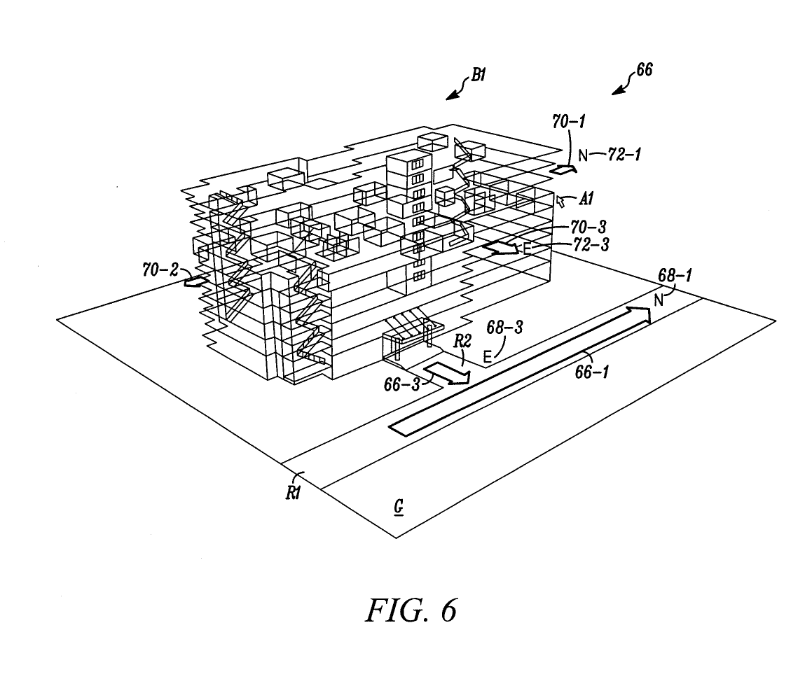

FIG. 6 illustrates an image 66 with an alternate form of presentation of directional indicia or cues relative to the orientation of the image of the building B1. In FIG. 6, directional indicating cues such as 66-1, -2 and -3 are presented at ground level on roads or drives such as R1, R2 in the vicinity of the building B1. The directional indicating letters such as 68-1, 68-3 are illustrated adjacent to the arrowheads of the direction indicating indicia 66-1, -3. In addition, where an object such as a floor or a room has been selected by a user, for example, by cursor A1, additional indicative directional cues or indicia can be presented outside of or in the vicinity of the selected object. For example, direction indicating arrows 70-1, -2, and -3 along with associated direction specifying alphabetical characters 72-1, -2 and -3 as illustrated in FIG. 6.

Those of skill will understand that the supplemental object associated indicia 70-1, 70-2 as well as 72-1, 2 could be used with previously discussed method and presentation as illustrated in FIG. 2.

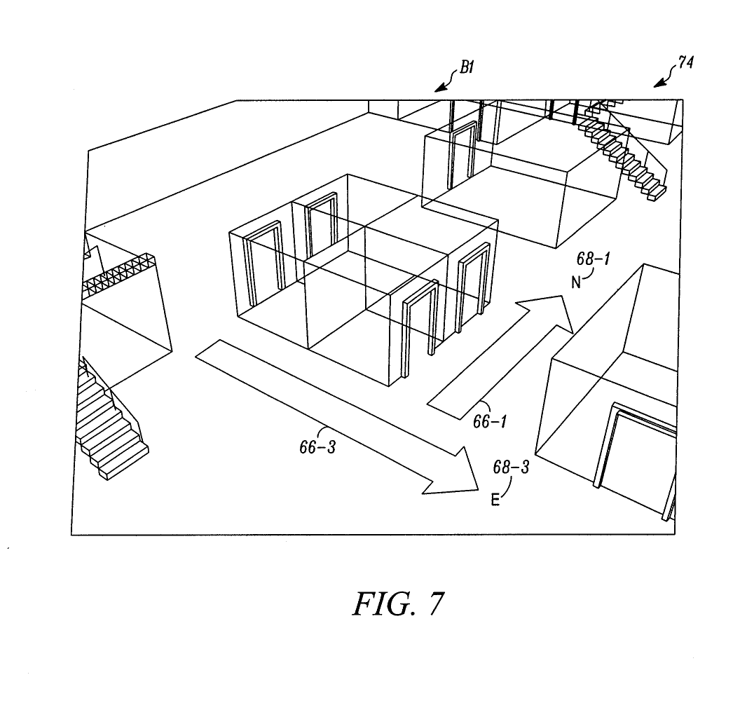

FIG. 7 illustrates an image 74 of a portion of the building B1 where the user has zoomed into the interior of a portion of the building. In the zoomed presentation of FIG. 7, the directional indicating indicia such as arrows 66-1, -3 and alphabetical representations 68-1, -3 would be presented on corridors or pathways which are in the displayed area. As discussed previously, as the degree of zooming increases, the presentation of the directional indicating indicia 66-1, -3 and associated alphabetical representations 68-1, -3 presented at a predetermined maximum size still within the viewable presentation or image 74.

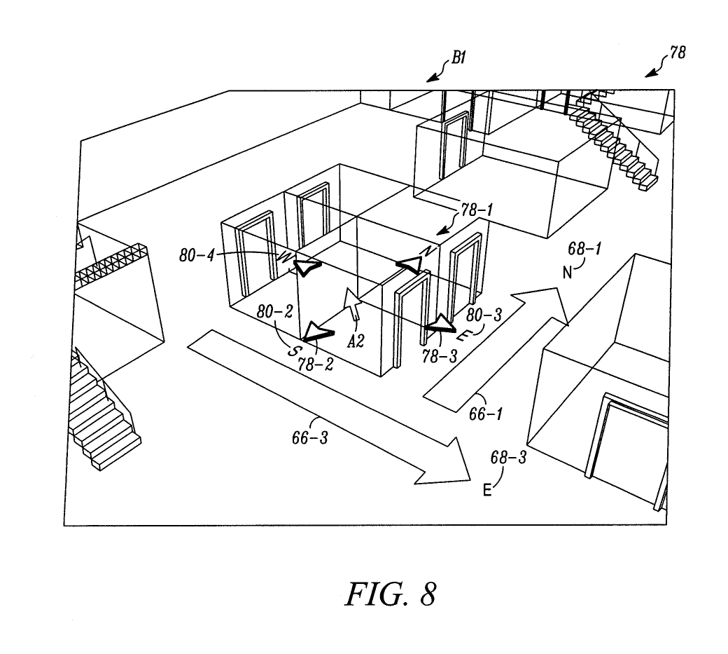

In FIG. 8, a display 78 of a portion of the building B1 illustrates a selected object, a room, selected by the user via cursor A2. In this instance, the supplemental and directional indicating indicia such as 78-1, -2, -3 and -4 are shown outside of the object selected by the cursor A2. Adjacent thereto are alphabetical designations such as 80-1, -2, -3 and -4.

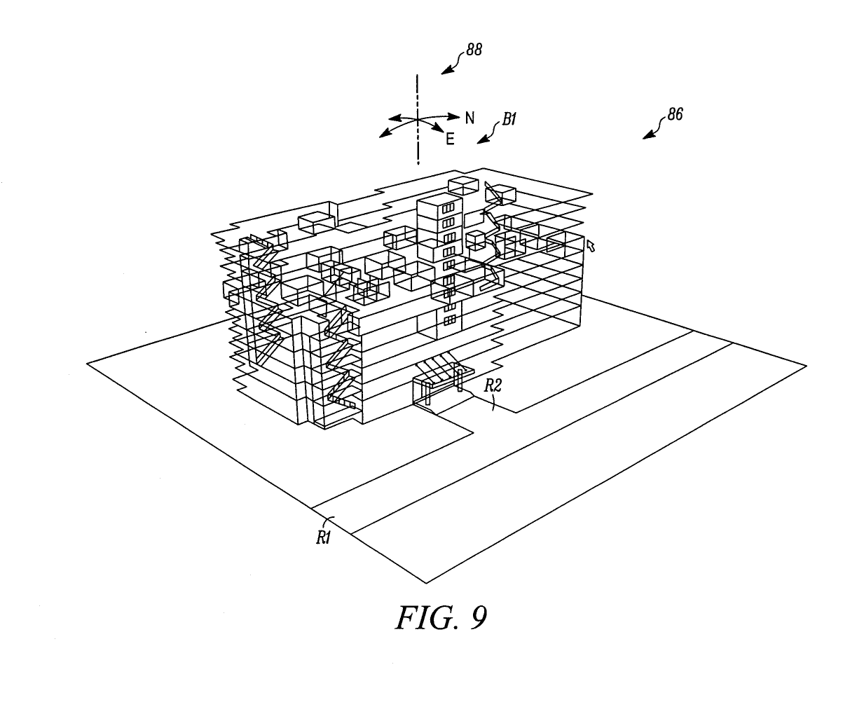

FIG. 9 illustrates an image 86 of building B1 in accordance with yet another method which embodies the invention. In the image 86, directional indicia or cues including directional arrows as well as directional indicating characters 88 can be presented on the display of the building B1 above the building. When the user rotates or otherwise manipulates the building, the directional cues 88 will be manipulated consistently along with the building B1.

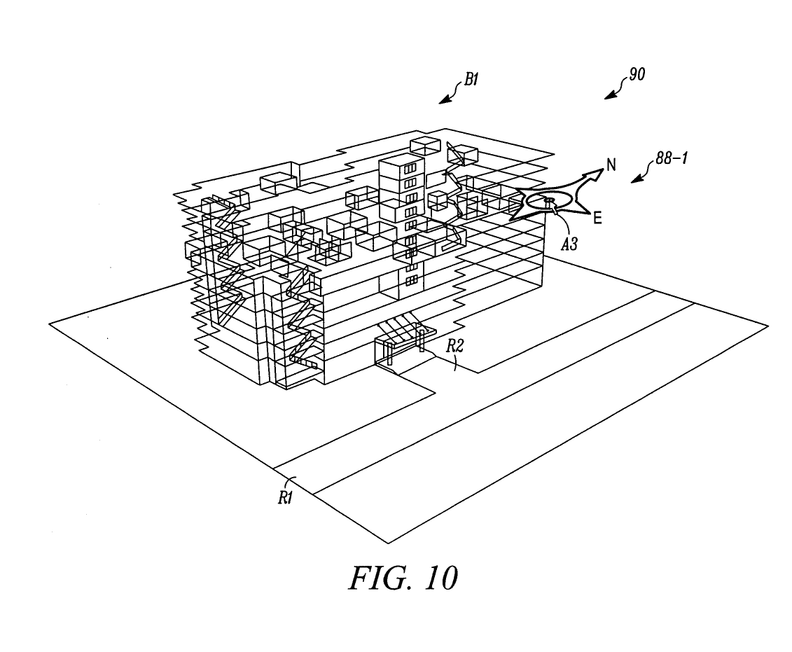

In FIG. 10, a display 90 of the building B1 includes composite directional indicating indicia 88-1 which is linked to cursor A3. When the cursor A3 is moved relative to the 3-dimensional representation of the building B1 the indicia 88-1 will be moved accordingly so as to maintain the appropriate directional orientation relative to the building. Presentation of the indicia 88-1 can be activated via a light button or hot key as desired.

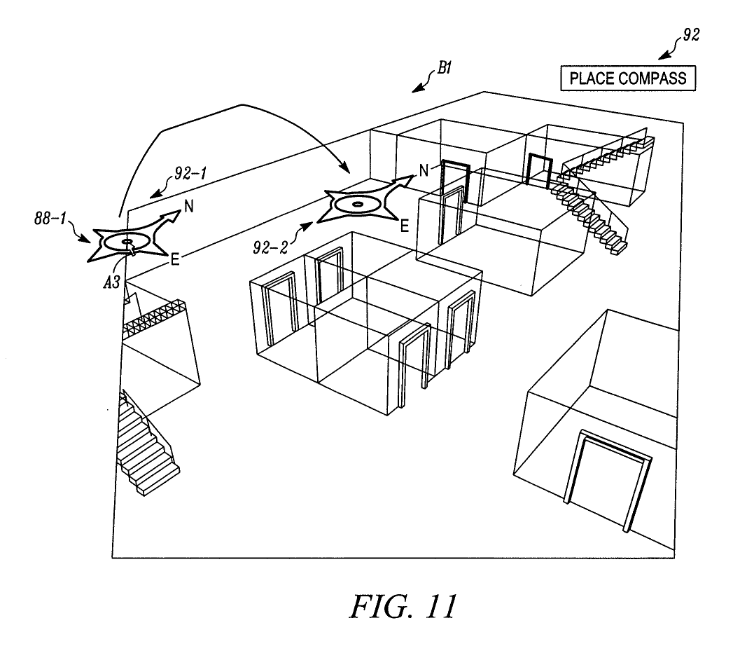

FIG. 11 illustrates use of the composite direction indicating indicia 88-1 in combination with the cursor A3. The user examining or viewing the image 92 on display 18-2 or 20e can activate via a light button or key, a “place compass function”. When implemented the subject function enables the user, via the cursor A3 to pick up and move the indicator 88-1 from an initial position 92-1 to a different position 92-2. When so positioned, the indicia 88-1 continues to exhibit the correct directional orientation relative to the portion of the building B1 present on the image 92.

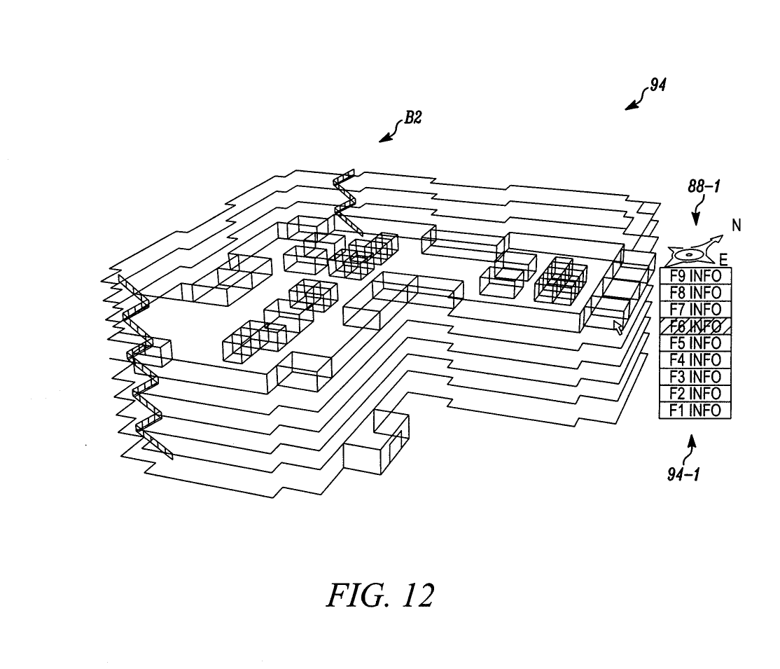

FIG. 12 illustrates yet another alternate method in accordance with the invention. In FIG. 12, an image 94 is presented relative to a building B2. In the presentation of the image 94, a floor such as 6th floor, can be selected using a floor number object 94-1. When a floor is selected, it will be illuminated apart from the rest of the building B2 as illustrated therein. In such an instance, the directional indicating indicia 88-1 can be presented in combination with the floor specifying object 94-1. As the building B2 is rotated, the directional indicating indicia 88-1 continues to maintain an appropriate orientation relative to the building B2 as the user manipulates same by rotation or zooming in and out.

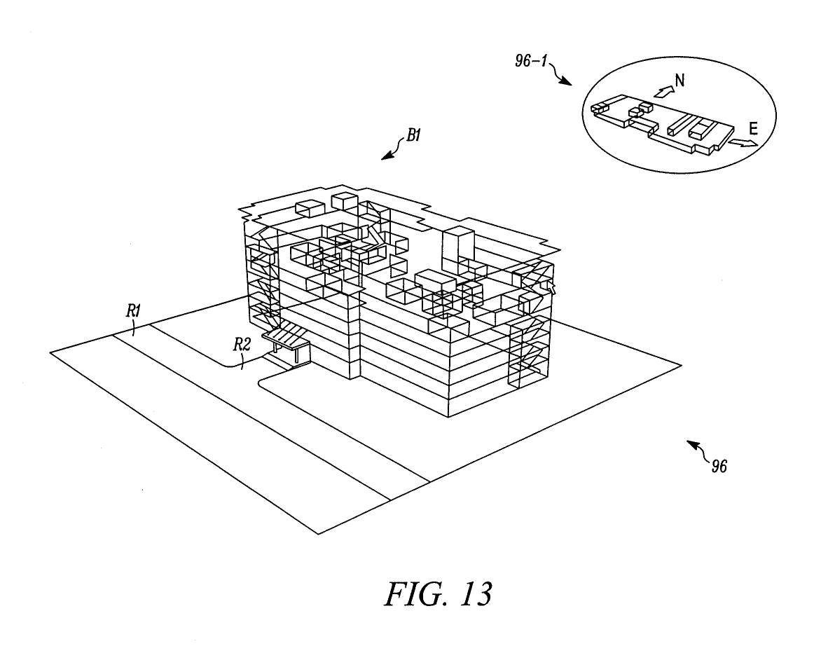

FIG. 13 illustrates another process in accordance with the present invention. In a display 96, which could be presented by software 20d on display unit 18-1 or 20e a representation in building B1 is presented with a selected rotational orientation. Directional cues including arrow shaped indicators and directional indicating characters are presented in an adjacent supplemental display 96-1. The display 96-1, illustrated outside of the image of the building B1, will change as the user or viewer manipulates the image of the building B1 by either rotation or zooming. In this directional indicating presentation, the indicator 96-1 can be displayed with an overview of the building B1, a specific floor, a portion of a floor or the like. In each instance the directional indicating indicia 96-1 will be displayed outside of but adjacent to the portion of the building B1 being imaged.

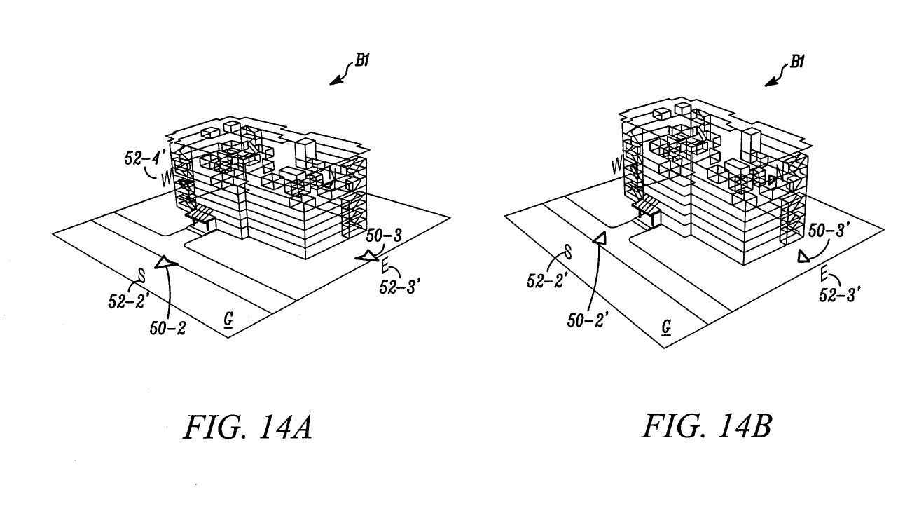

FIGS. 14A and 14B illustrate variations on possible orientations of directional indicating symbols or letters. For example, in FIG. 14A, the directional indicating letters such as 52-3′ or 52-2′ are illustrated perpendicular to the ground plane G as well as to the symbols 50-2 and 50-3.

In FIG. 14B the orientation of the directional indicating symbols 50-2′, 50-3′ have also been turned so as to be perpendicular to the ground plane G.

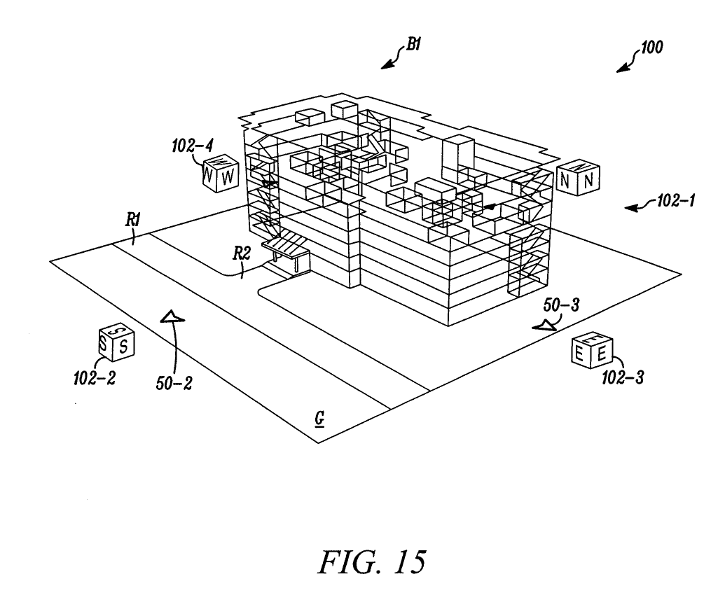

FIG. 15 illustrates yet another process in accordance with the present invention. In the presentation of the image of the building B1 of FIG. 15 in image 100, alternate forms of the directional indicating alphabetical characters 102-1, -2, -3 and -4 have been illustrated. Those of skill will understand that other alphabetical representations come within the spirit and scope of the present invention. The cubes represented in FIG. 15 can be presented with the directional indicating symbols present on each of the six surfaces thereof. The user can thus see the subject and relevant character from any view point.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
presenting an image of a three dimensional building on a display unit; and
displaying multi-part direction indicating indicia at multiple locations around and proximate to the building thereby creating a unitary visual presentation while rotating or enlarging the image.

2. A method as in claim 1 where displaying indicia includes displaying an asymmetrical direction indicating symbol in combination with an adjacent alphabetical symbol.

3. A method as in claim 2 comprising displaying the direction indicating symbol in one plane and the alphabetical symbol in one plan and the alphabetical symbol in one of the one plane or a second plane perpendicular to the one plane.

4. A method as in claim 3 which includes rotating the image of the building about a selected axis.

5. A method as in claim 4 where the direction indicating indicia move as the image is being rotated to maintain a constant directional indicating relationship with the image of the indicating building.

6. A method as in claim 5 thereby where presenting includes zooming into enlarging and displaying a region of the building.

7. A method as in claim 6 which includes moving at least one of the indicia into the displayed region of the building while maintaining constant directional relationship with the image of the indicating building.

8. A method as in claim 6 where displaying the region includes displaying at least one of corridors or paths in the region.

10. A method as in claim 9 where displayed indicia comprise an asymmetrical direction indicating symbol and a direction specifying alphabetic symbol.

11. A method as in claim 10 which includes selecting an object in the region being displayed and displaying at least some of the indicia adjacent to the selected object.

12. A method as in claim 11 which includes moving direction indicium to a selected location in the region with the direction indicating symbol maintaining its direction indicating orientation as the region is being at least one of rotated or enlarged.

13. A method as in claim 1 where the indicia are located at one of above or beside the presented image.

14. A system comprising:
a programmable processor;
a multi-dimensional display device coupled to the processor; and
building display software, stored on a computer readable medium and executable by the processor to present on the display device at least a portion of a selected building, and including additional software to display direction indicating indicia at multiple locations around and proximate to the building thereby creating a unitary visual presentation.

15. A system as in claim 14 where the indicia presented by the additional software includes an asymetric directional orienting symbol adjacent to a directional specifying letter at each location.

16. A system as in claim 15 where the symbol and the letter are presented in on of, the same plane, or different planes.

17. A system as in claim 14 where the display software provides a reversible enlargement/reduction function with the indicating indicia maintained on a visible portion of the selected building, as the building is enlarged, or reduced.

18. A system as in claim 17 with the indicating indicia having upper and lower size limits irrespective of the degree of enlargement/reduction to maintain visibility thereof.

19. A system as in claim 17 with further software to select a structural feature of a portion of a displayed building with supplemental direction indicating indicia displayed adjacent thereto.

20. A system as in claim 19 where the indicia presented by the additional software includes an asymetric directional orienting symbol adjacent to a directional specifying letter at each location.
